(19) United States
(12) Patent Application Publication
(10) Pub. No.: US 2018/0153154 A1
(43) Pub. Date: Jun. 7, 2018

(54) Pinniped Deterrent

(71) Applicants: Rodger Cosgrover, North Tustin, CA (US); Kenton Abel, Hacienda Heights, CA (US)

(72) Inventors: Rodger Cosgrover, North Tustin, CA (US); Kenton Abel, Hacienda Heights, CA (US)

(73) Assignee: Rodger Cosgrove, North Tustin, CA (US)

(21) Appl. No.: 15/371,189

(22) Filed: Dec. 6, 2016

(51) Int. Cl. A01M 29/30; A01K 75/00; E04B 1/72; E02B 17/00; B63B 59/04

(52) U.S. Cl. CPC A01M 29/30; A01K 75/00; B63B 2710/00; E02B 17/0017; B63B 59/04; E04B 1/72

(57) ABSTRACT

A method for deterring pinnipeds from an area by deploying a movable array of deterrent devices over the area to be protected.

This application claims priority to U.S. Ser. No. 62/263,734, titled “Pinniped Deterrent,” filed Dec. 6, 2015.

### FIELD OF THE INVENTION

The present invention relates to systems, methods and apparatus to repulse and/or prevent damage to property by occupation or roosting by pinnipeds on developed waterfront, decks, docks, floats, piers, bait receivers, vessels at anchor, and other places.

### BACKGROUND OF THE INVENTION

Pinniped is the category of semiaquatic marine mammals which includes seals, sea lions, and walruses. Pinnipeds belong to the order Carnivora and their closest living relatives are bears and musteloids (weasels, raccoons, skunks and red pandas.) Sea lions in particular are a significant problem to humans along many bayfront and oceanfront properties, and on floating structures such as docks and boats. These animals like to haul themselves out of the water to rest, warm up, escape predators. Because they are social animals, pinnipeds will just “hang out” together if a comfortable spot is available.

When pinnipeds occupy human owned property they are almost always considered a nuisance for many reasons: A) Pinnipeds often damage personal property, both dockside and on boats. Indeed, many boats have been severely damaged and even sunk by pinniped occupation. B) Pinnipeds excrete disgusting brown mucus from their muzzles that gets flung all about their environs and is difficult to clean off. C) Pinnipeds defecate all about their environs, often copiously, leaving a general miasmic mess. D) Pinnipeds can be huge animals with long, pointy-sharp teeth, not unlike an 800-pound dog that sometimes bites. E) Pinnipeds will make a lot of noise, baying and barking all night long. Pinniped noise is especially bad during mating season. Nearby sleep deprived humans become angry, confused, forgetful, and unsafe drivers. F) Pinnipeds eat the nearby fish that property and boat owners like to see propagate, and to catch.

Pinniped related costs to clean up the mess, to repair or replace damaged property, and to compensate for lost use of waterfront facilities can be millions of dollars annually for a single ocean front city.

Pinnipeds were formerly hunted down to small numbers, some types becoming nearly extinct, so laws were passed in the 1970's to protect them from humans. However, several decades later the pinniped population has increased dramatically in many places, and the nuisance factor, expense, and danger to humans has increased proportionately. Although it is illegal to harm pinnipeds the following are National Oceanic and Atmospheric Administration (NOAA) suggested methods pinniped deterrence as set forth in “Potential Deterrence Methods for Pacific Harbor Seals, California Sea Lions, & Eastern U.S. stock Steller sea lions,” NOAA Fisheries West Coast Region, August 2014)

Barriers & Exclusion Devices:
fencing (e.g., plastic construction/snow fence, chain link)
closely spaced posts
bull rails
electric livestock fencing
netting
swim step protector

Visual Repellents:
flags, pinwheels, or streamers
flashing lights or strobes
balloons
human attendants/monitors

Noise Makers:
horns, whistles, bells
electronic acoustic devices (Acoustic Harassment Devices)
clapping, banging on pots, pans, drums; empty aluminum cans on a string banging together
music
starter pistols
pyrotechnics (e.g., bird screamers, bangers, firecrackers)
propane canons

Physical Contact:
high or low pressure water hoses
sprinklers, sprayers
crowder boards
bull poles (blunt tip), brooms
cattle prod (these products produce only a mild electric shock designed for handling livestock and are in no way related to “stun guns” designed for self-defense)
toy water guns (e.g., “Super Soaker©”)
non-toxic and water soluble paint ball or air soft guns
slingshot
chemical irritants (e.g., non-toxic pepper spray, mace) used for animal control (there are many municipal and state ordinances controlling the use and possession of these irritants)

Note: Guard dogs are not included on the list of suggested measures because of risks to both dogs and marine mammals, including the potential risk of disease transmission between them.

The following are NOT appropriate methods according to NOAA:
No firearms with “live” (lethal) ammunition
No devices with injurious projectiles (e.g., archery gear, crossbows, spear guns, bangsticks)
No sharp/pointed objects (e.g., harpoons, spears, gaffs, nail studded bats/poles/clubs)
No entangling devices (e.g., loose webbing, snares, concertina wire)
No aggressive tactile methods (e.g., striking animals with bats, hammers etc., impact with vehicles or boats)
No tainted baits or poisons

Regardless of method or intent, the property owner or fisher may be subject to prosecution should a marine mammal be seriously injured or killed as a result of deterrence efforts for the protection of property, gear or catch.

The methods of chasing away pinnipeds are inconvenient and often frightening. The methods of deterring pinnipeds from property are very inconvenient, and they all significantly compromise or even eliminate the functionality of the property being protected. For example, putting a fence around a boat dock renders it unusable, or usable but much more dangerous and difficult to use.

Another method to keep pinnipeds away from a surface is to affix hard objects to that surface that would make it uncomfortable for a pinniped to lie on, but would not puncture or seriously harm the animal. The problem with this method is that there are then a lot of affixed and unsightly tripping hazards underfoot. Like the barriers described above, this method also seriously compromises the functionality and safety of the area to be protected.

There is a need for an effective method of deterring pinnipeds from property that does not render the area unusable, or usable but much more dangerous and difficult to use.

### SUMMARY OF THE INVENTION

The present invention provides systems, methods and apparatus to deter pinnipeds from occupation or roosting on developed waterfront, decks, docks, floats, piers, bait receivers, vessels at anchor, and other places. In one embodiment, the system includes an array of deterrent devices which cover an area to be protected (the “protected area”) when the system is in an open (“deployed”) configuration, but does not cover the protected area when in a closed (“storage”) configuration. The system allows the array of devices to easily be moved between the storage to the deployed configuration, and back again.

### BRIEF DESCRIPTION OF THE DRAWINGS

FIG. 1A is a picture of California sea lions resting on a dock. FIG. 1B is a picture of California sea lions resting on an anchored boat.

FIG. 2A is a top view of one embodiment of the present invention in a “storage” or closed configuration. FIG. 2B is a top view of one embodiment of the present invention in a “deployed” or open configuration.

FIG. 3 is a perspective view of one embodiment of the present invention in a deployed configuration.

FIG. 4 is a cut-away perspective view of one embodiment of the present invention in a deployed configuration.

FIG. 5 is a perspective view of one embodiment of the present invention with tetrahedron deterrents in a deployed configuration.

FIG. 6A is a perspective view of a net embodiment with attached tetrahedron deterrent device. FIG. 6B is a close up view of a net embodiment with attached tetrahedron deterrent device.

FIGS. 7A and 7B are perspective views of embodiments of possible shapes of tetrahedral deterrent devices.

### DETAILED DESCRIPTION OF THE INVENTION

“Array” means a plurality of deterrent devices arranged in a manner to deter pinnipeds from a protected area.

“Deterrent device” means a device which creates an uncomfortable stimulation for a pinniped. Deterrent devices include passive devices and active devices. Passive devices include uncomfortable structures, such as pegs and tetrahedral shaped objects. Active devices include electric shock devices, noise makers and the like. To comply with NOAA guidance, electric shock devices need to be uncomfortable but not injurious, similar to a cattle prod.

“Protected area” means any surface which pinnipeds will not occupy due to deployment of an array of deterrent devices.

In a preferred embodiment, lights may be placed in the deterrent devices to warn both humans and pinnipeds of the protected area. In a more preferred embodiment, LED or similar efficient and long lasting lights are used in the devices.

The deterrent devices can be comprised of any suitable material, such as durable plastic, rubber, wood, composite materials, recycled carpet fiber (e.g. NyloBoard®), etc.

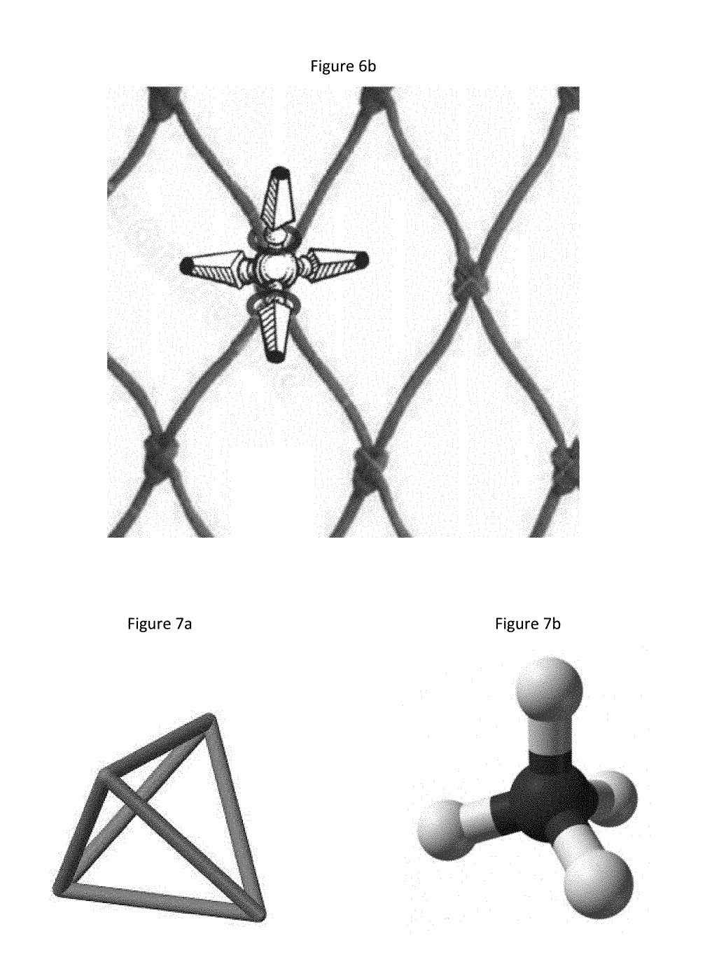

The exact shape of the deterrent device includes any geometric configuration which allows for the array of devices to move between a storage configuration to a deployed configuration and back, as long as the shape does not injure the pinniped. Preferred shapes include pegs, cones and tetrahedrons. Two embodiments of tetrahedron shape deterrent devices are shown in FIGS. 6A and 6B.

The deterrent devices could be either passive, i.e., merely a shape that is uncomfortable to a pinniped, or they could be active, such as an electrical shocking device. The deterrent device could have any of several shapes, and they could be either rigid or they could “fold over” to minimize the possibility of injury to any animal or person.

The size of the devices may vary as long as the height of the device is sufficient to cause the pinniped sufficient discomfort to not occupy the protected area.

### Example 1. Horizontal “Scissors” Style Folding Matrix Supporting Vertical Pegs

One embodiment of the invention is a collapsible framework that supports “pinniped-unfriendly” pegs or attachments to deter pinnipeds from protected areas. This framework is constructed like the familiar “scissors” style security gate to create a folding grid, with two sets of parallel arms or struts. Each set adjoining the other at a plane where they are hinged together at regular intervals to form the vertices of collapsible parallelograms, or “folding diamonds.” For this invention the hinge at each vertex is a receiver or connector device to support a peg or other device perpendicular to the plane of the folding grid. One embodiment of this vertex hinge would have a threaded female receiver socket into which the projecting peg could be secured.

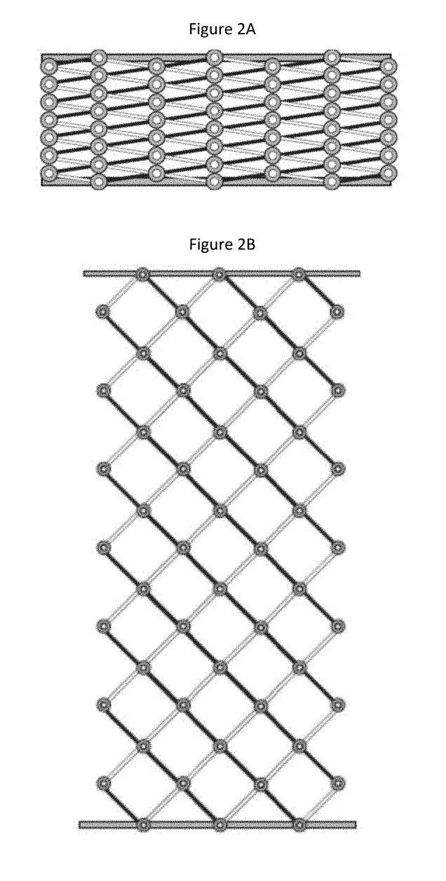

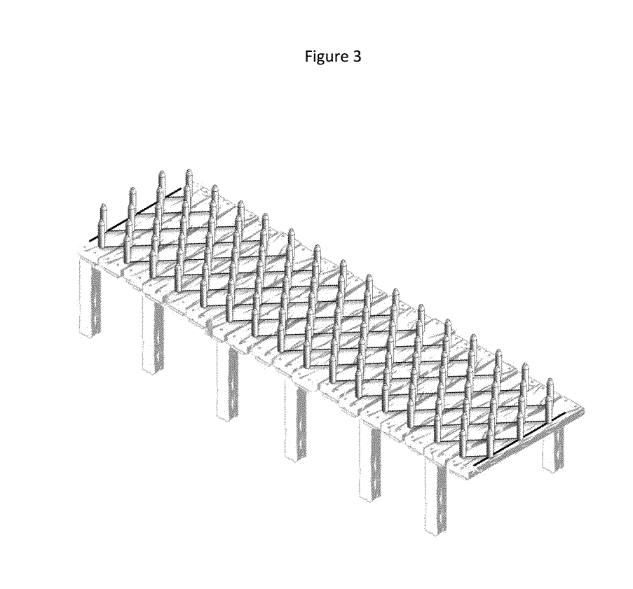

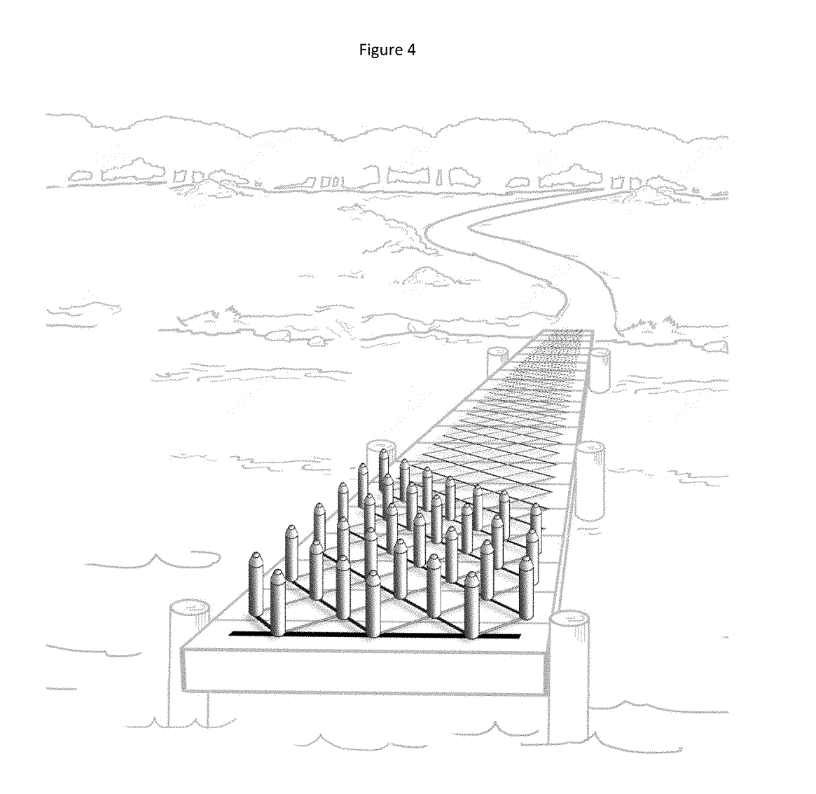

Depending on the width of the parallel arms, and on the spacing of the vertices, such a collapsible framework can expand in the deployed configuration to many times its collapsed or folded width in the storage configuration. The collapsible framework is placed at one end of an area to be protected, either permanently or temporarily. When the framework is in the storage configuration (as shown in FIG. 2A), the adjacent protected area is open and free of any obstructions. When the framework is in deployed configuration (as shown in FIGS. 2B, 3 and 4), the adjacent area is filled at the deterrent devices to prevent pinnipeds from occupying the protected area.

In a preferred embodiment, the scissor style deterrent system includes lights, such as LED lights.

### Example 2. Tetrahedron-Shaped Deterrent Devices

In one embodiment of the present invention, a plurality of sturdy tetrahedron-shaped devices are attached to each other in a spaced manner such that a pinniped will be unable to roost on the protected area without laying on one or more of the deterrent devices. The tetrahedron shape essentially creates to a non-lethal and non-injury causing caltrop. Another advantage of the caltrop sharp is that the device is less likely to be damaged when a pinniped attempts to occupy the protected area. A 2000-pound male Steller sea lion might create enough force on a narrow peg shaped deterrent to either break the peg or push the peg through the protected area.

The tetrahedron-shaped devices can be made from any suitable material, such as durable plastic, rubber, wood, composite materials, recycled carpet fiber (e.g. NyloBoard®), etc. The size of the devices may vary as long as the height of the device is sufficient to cause the pinniped sufficient discomfort to not occupy the protected area. The exact shape of the device may also vary, as long as the top does not injure the pinniped. Another embodiment of a tetrahedron shape is shown in FIGS. 6A and 6B.

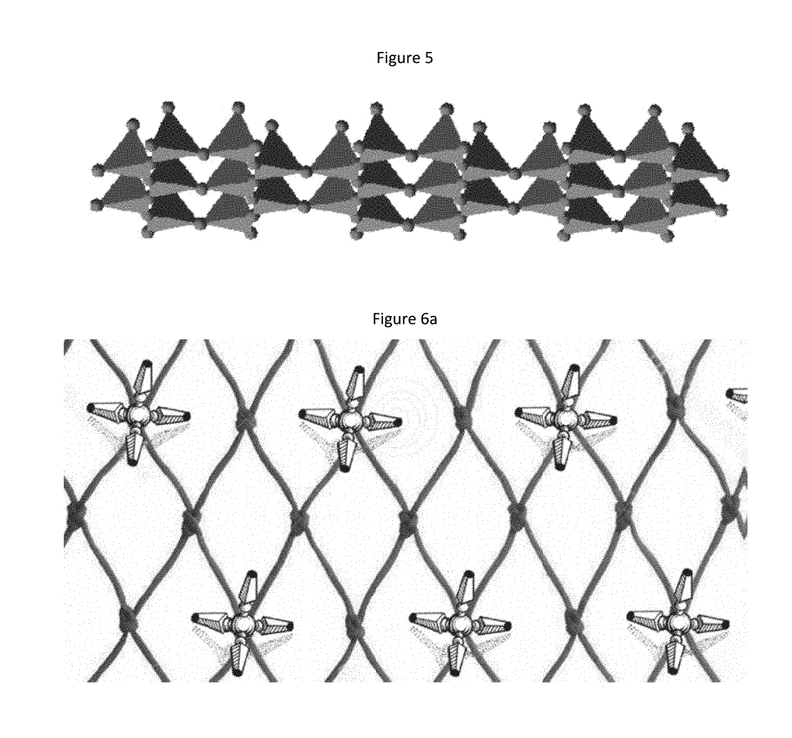

One embodiment of an array of tetrahedron-shaped devices is shown in FIG. 5. In this embodiment, the devices are flexibly linked together at the bottom corners. The array can be rolled up for storage while the protected area is in use, and then deployed again for deterrence while humans are not using the protected area.

In another embodiment, the tetrahedron-shaped devices are connected to a “scissors” style folding matrix as generally described in Example 1 and shown in FIGS. 2 through 4.

In another embodiment, the tetrahedron-shaped devices are connected in an array to a net. The net can be made from any suitable material to withstand the exposure to the elements and pinnipeds.

In a preferred embodiment, the tetrahedron deterrent system includes lights, such as LED lights.

### Example 3. Electric Deterrent

In one embodiment, the deterrent system is comprised of an array of electric shock devices. In a preferred embodiment, the storage configuration is shown in FIG. 2A and deployed configuration is shown in FIG. 2B. At the intersections of the parallel arms, a device is located which will shock a pinniped when weight is applied. When no weight is applied to the array, the devices are not turned on. Thus, in a wet environment like an ocean front dock, no electric charge will be released into spray caused by waves or rain.

In a preferred embodiment, the electric deterrent system includes lights, such as LED lights.

### Example 4. Boat Protection with Deterrent Net

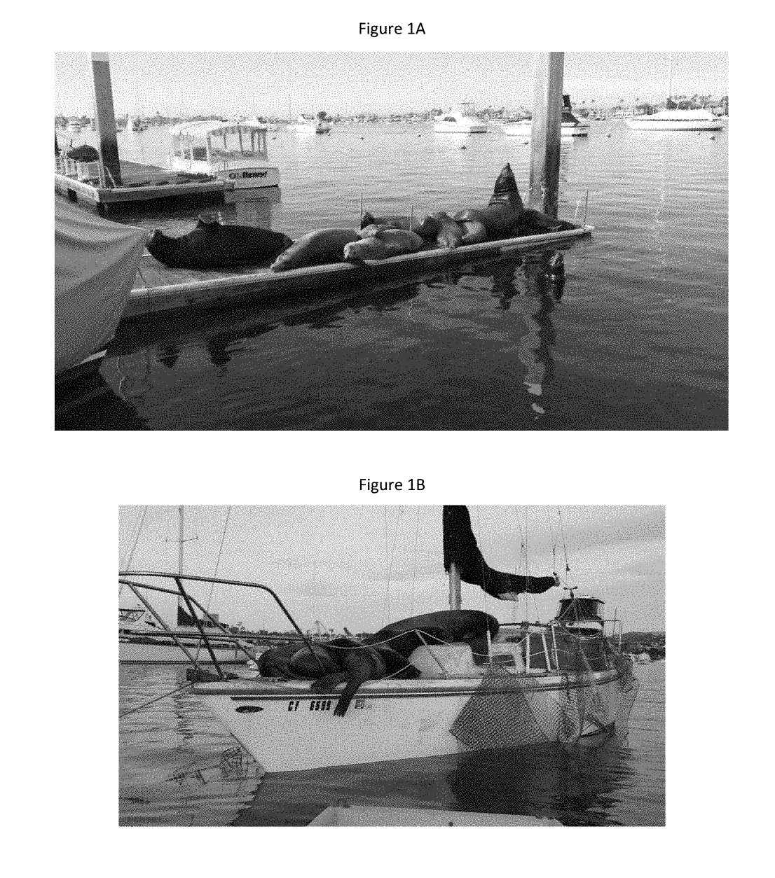

As shown in FIG. 1B, pinnipeds often jump onto anchored boats. While the harbor patrol will regularly chase the pinnipeds away, the pinnipeds return soon after the harbor patrol leaves.

In one embodiment, the deterrent system is comprised of an array of deterrent devices attached to a net (a “deterrent net”), as illustrated in FIGS. 6A and 6B. The deterrent net is secured or placed on top of to any surfaces of the boat where a pinniped may roost or walk, thus creating protected areas. With the deterrent net deployed, the pinnipeds will not roost on the protected area. In order to use protected areas of the boat, the owner moves the net from the area and optionally stores it in a container. The protected areas of the boat can then be used by humans without the hindrance of the deterrent devices. When the boat is brought back to anchorage, the deterrent net can be deployed again to deter pinnipeds.

In a preferred embodiment, the deterrent devices are removably connected to the net, such as with a clip, flexible ring, wire, etc.

In a preferred embodiment, the deterrent net includes lights, such as LED lights.

1. A method for deterring pinnipeds from an area comprising deploying an array over the area, wherein the array comprises a plurality of attached deterrent devices.

2. The method of claim 1, wherein the deterrent devices are tetrahedron shaped.

3. The method of claim 2, wherein the array comprises a net.

4. The method of claim 2, wherein the deterrent devices are removably attached to the array.

5. The method of claim 3, wherein the area is a bow on a boat.

6. The method of claim 5, wherein the deterrent devices are removably attached to a net.

7. The method of claim 1, wherein the array is removably attached to the area.

8. The method of claim 7, wherein the array comprises a net.

9. The method of claim 8, wherein the deterrent devices are tetrahedron shaped.
